(19) United States
(12) Patent Application Publication
(10) Pub. No.: US 2026/0347152 A1
(43) Pub. Date: Nov. 5, 2026

(54) LIFTING TOOL AND LIFTING METHOD

(71) Applicant: MITSUBISHI HEAVY INDUSTRIES, LTD., Tokyo (JP)

(72) Inventor: Ryota CHAKI, Tokyo (JP)

(21) Appl. No.: 18/997,700

(22) PCT Filed: Jul. 28, 2023
(86) PCT No.: PCT/JP2023/027780

§ 371 Date: Jan. 22, 2025

(30) Foreign Application Priority Data
Aug. 5, 2022 (JP) 2022-125213

(51) Int. Cl. B66C 1/30; F01D 5/30

(52) U.S. Cl. CPC B66C 1/30; F01D 5/3007; F05D 2230/68

(57) ABSTRACT

A lifting tool includes: a holding part which has a pair of holding pieces extending in the vertical direction and rotatably connected to each other and constituting a cross-link mechanism for opening and closing lower ends and upper ends of the holding pieces; and a pair of lifting parts at the lower ends of the pair of holding pieces. The lifting parts each comprises: a first member protruding from the lower end of the corresponding holding piece in the closing direction of the lower end and having a supporting surface to support a bottom surface of the shroud from below; and a second member protruding in the closing direction above the first member, by a protrusion length shorter than that of the first member, and having an abutment surface capable of abutting against a lateral surface of the shroud.

### TECHNICAL FIELD

The present disclosure relates to a lifting tool and a lifting method.

Priority is claimed on Japanese Patent Application No. 2022-125213 filed on Aug. 5, 2022, the content of which is incorporated herein by reference.

### BACKGROUND ART

For example, PTL 1 discloses a technique of lifting an arc-shaped inner shroud together with a lifting jig (lifting tool) by attaching the lifting jig to both end portions of the inner shroud and hooking a hook of a lifting device such as a crane onto a shackle.

### CITATION LIST

### Patent Literature

[PTL 1] Japanese Unexamined Patent Application Publication No. 2012-246124

### SUMMARY OF INVENTION

### Technical Problem

Meanwhile, in a case where a gas turbine blade is attached to a rotor shaft of a turbine, the gas turbine blade may be lifted in a blade height direction by using a lifting tool. In this case, for example, when a blade root on a lower end side of the gas turbine blade is inserted into a groove formed in the rotor shaft, a lifted state of the gas turbine blade by the lifting tool may be released, and most of the load of the gas turbine blade may be applied to the groove.

Therefore, the entire blade root is inserted into the groove while adjusting an orientation and a position of the blade root in a state in which the load of the gas turbine blade is applied to the groove, which may require a significant force or time for the attachment work of the gas turbine blade. That is, there is a problem in that it is difficult to smoothly attach the gas turbine blade to the rotor shaft.

The present disclosure has been made to solve the above-described problem, and an object of the present disclosure is to provide a lifting tool and a lifting method capable of smoothly attaching a gas turbine blade to a rotor shaft.

### Solution to Problem

In order to achieve the above-described object, according to the present disclosure, there is provided a lifting tool for a gas turbine blade provided with a shroud at a tip, the lifting tool including: a clamp part that includes a pair of clamp pieces extending in an up-down direction and connected to each other in a rotationally movable manner and that forms a cross-link mechanism in which lower ends and upper ends of the pair of clamp pieces each open and close; and a pair of lifting parts that are provided at the lower ends of the pair of clamp pieces, respectively, in which the lifting parts each include a first member that protrudes from the lower end of the clamp piece in a closing direction of the lower end and that includes a support surface configured to support a lower surface of the shroud from below, and a second member that protrudes in the closing direction above the first member by a protrusion length shorter than that of the first member and that includes an abutting surface configured to abut against a side surface of the shroud.

According to the present disclosure, there is provided a lifting method of lifting a gas turbine blade provided with a shroud at a tip by using a lifting tool, the lifting tool including a clamp part that includes a pair of clamp pieces extending in an up-down direction and connected to each other in a rotationally movable manner and that forms a cross-link mechanism in which lower ends and upper ends of the pair of clamp pieces each open and close, and a pair of lifting parts that are provided at the lower ends of the pair of clamp pieces, respectively, the lifting parts each including a first member that protrudes from the lower end of the clamp piece in a closing direction of the lower end and that includes a support surface configured to support a lower surface of the shroud from below, and a second member that protrudes in the closing direction above the first member by a protrusion length shorter than that of the first member and that includes an abutting surface configured to abut against a side surface of the shroud, the lifting method including: a blade clamp step of supporting the lower surface of the shroud with the first member and abutting the second member against the side surface of the shroud, with the closing direction set as a direction in which a side surface facing an upstream side and a side surface facing a downstream side among the side surfaces of the shroud are pinched; and a blade lifting step of lifting the lifting tool to an upward side.

### Advantageous Effects of Invention

According to the present disclosure, it is possible to provide a lifting tool and a lifting method capable of smoothly attaching a gas turbine blade to a rotor shaft.

### BRIEF DESCRIPTION OF DRAWINGS

FIGS. 1A and 1B are a front view and a side view illustrating a configuration of a lifting tool according to an embodiment of the present disclosure, and the side view of FIG. 1B is a view as seen from a B-B line direction in the front view of FIG. 1A.

FIGS. 2A to 2D are diagrams illustrating a state in which a rotational movement amount of a pair of clamp pieces is restricted by a locking mechanism according to the embodiment of the present disclosure.

FIG. 3 is a flowchart showing a blade attachment method according to the embodiment of the present disclosure.

FIGS. 4A and 4B are diagrams illustrating a blade attachment step according to the embodiment of the present disclosure.

FIGS. 5A and 5B are diagrams illustrating a configuration of a gas turbine blade according to the embodiment of the present disclosure.

### DESCRIPTION OF EMBODIMENTS

Hereinafter, an embodiment of a lifting tool and a lifting method according to the present disclosure will be described with reference to the accompanying drawings.

### Lifting Tool

The lifting tool in the present embodiment is a tool for lifting a gas turbine blade. The lifting tool is used for assembly during turbine manufacturing for the gas turbine, disassembly and reassembly during turbine maintenance, and the like. In the assembly during turbine manufacturing, the gas turbine blade is attached to a rotor shaft of the turbine while maintaining the gas turbine blade in a lifted state by using the lifting tool.

Here, a configuration of the gas turbine blade to be lifted by the lifting tool will be described.

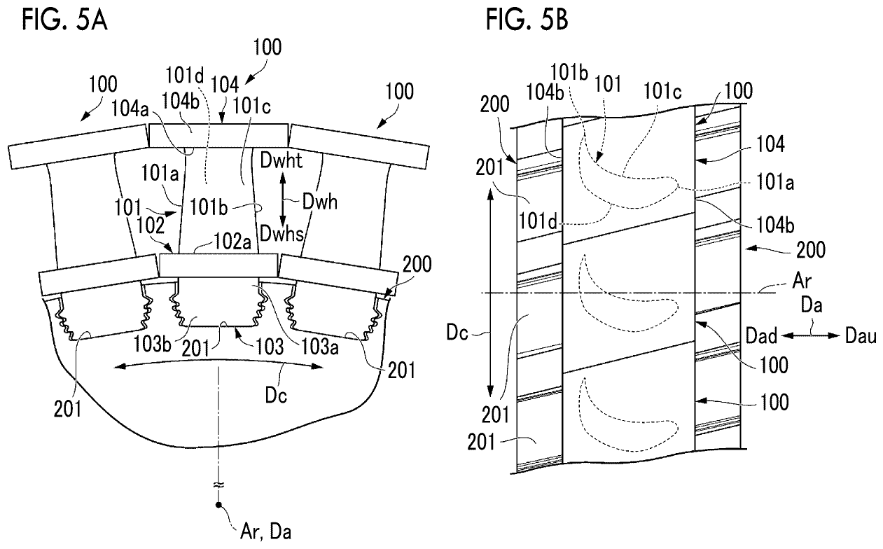

As shown in FIGS. 5A and 5B, a plurality of gas turbine blades 100 are attached to a disk of a rotor shaft 200 of a turbine (the overall configuration is not shown). The rotor shaft 200 forms a columnar shape extending in a direction in which an axis Ar extends and serves as a rotary shaft that is rotatable around the axis Ar. The plurality of gas turbine blades 100 that are attached are disposed at equal intervals in a circumferential direction of the rotor shaft 200.

Hereinafter, for convenience of description, a direction in which the axis Ar, which is a rotation center of the rotor shaft 200, extends will be referred to as an “axial direction Da”, a circumferential direction with respect to the axis Ar will be simply referred to as a “circumferential direction De”, and a direction perpendicular to the axis Ar will be referred to as a “radial direction”. In addition, one side of both sides in the axial direction Da will be referred to as an “axial upstream side Dau”, and the opposite side thereof will be referred to as an “axial downstream side Dad”.

The axial upstream side Dau in the present embodiment is a side from which combustion gas generated by a combustor (not shown) of the gas turbine flows, and the axial downstream side Dad is a side on which the combustion gas flows away.

### (Gas Turbine Blade)

The gas turbine blades 100 are rotor blades that are arranged in a plurality of rows in the circumferential direction Dc by being attached to the rotor shaft 200. Hereinafter, for convenience of description, the gas turbine blade 100 will be referred to as a “rotor blade 100”. By arranging the rotor blades 100 in a plurality of rows in the circumferential direction De on the rotor shaft 200, the plurality of rotor blades 100 form a blade row (blade group).

The rotor blade 100 includes a rotor blade body 101, a platform 102, a shaft attachment portion 103, and a shroud 104.

### (Rotor Blade Body)

The rotor blade body 101 has an airfoil-shaped cross-section and extends in a direction perpendicular to the cross-section. Hereinafter, for convenience of description, this direction will be referred to as a “blade height direction Dwh”. In a state in which the rotor blade 100 is fixed to the rotor shaft 200, the blade height direction Dwh coincides with the radial direction of the rotor shaft 200. Here, a side of the rotor shaft 200 with respect to the rotor blade body 101 in the blade height direction Dwh will be referred to as a “hub side Dwhs”, and an opposite side thereof will be referred to as a “tip side Dwht”.

The rotor blade body 101 includes a leading edge 101a, a trailing edge 101b, and a ventral surface 101c and a dorsal surface 101d that connect the leading edge 101a and the trailing edge 101b and that face opposite sides to each other.

The leading edge 101a is an edge of the rotor blade 100 that is closest to the axial upstream side Dau in a state in which the rotor blade 100 is fixed to the rotor shaft 200. The trailing edge 101b is an edge of the rotor blade 100 that is closest to the axial downstream side Dad in a state in which the rotor blade 100 is fixed to the rotor shaft 200. The ventral surface 101c is a positive pressure surface that is curved in a concave shape. The dorsal surface 101d is curved in a convex shape toward a side on which the ventral surface 101c is concave and is a negative pressure surface that faces an opposite side with respect to the ventral surface 101c.

### (Platform)

The platform 102 is a base that supports the rotor blade body 101. The platform 102 is provided at an end portion of the rotor blade body 101 on the hub side Dwhs. The platform 102 is a plate-like member that expands in a direction having a component perpendicular to the blade height direction Dwh from the end portion of the rotor blade body 101 on the hub side Dwhs. A gas path surface 102a that faces the tip side Dwht and that comes into contact with combustion gas is formed on the platform 102.

### (Shaft Attachment Portion)

The shaft attachment portion 103 fixes the platform 102 to the rotor shaft 200. The shaft attachment portion 103 includes a shank 103a that extends from the platform 102 to a side opposite to the rotor blade body 101 in the blade height direction Dwh, and a blade root 103b that extends from the shank 103a to the side opposite to the rotor blade body 101 in the blade height direction Dwh. A cross-sectional shape of the blade root 103b forms a Christmas tree shape. The blade root 103b can be fitted into a blade root groove 201 formed in the rotor shaft 200.

### (Shroud)

The shroud 104 is provided at an end portion of the rotor blade body 101 on the tip side Dwht. Therefore, the tip (tip side Dwht) of the gas turbine blade 100 is provided with the shroud 104. The shroud 104 expands from the rotor blade body 101 in a direction perpendicular to the radial direction. Each shroud 104 abuts against adjacent shrouds 104 in the circumferential direction De when the rotor blades 100 are attached to the rotor shaft 200 to form the blade row, thereby increasing the overall rigidity of the blade row. The shroud 104 includes a side surface 104b facing the axial upstream side Dau and a side surface 104b facing the axial downstream side Dad when the rotor blade 100 is attached to the rotor shaft 200. Additionally, the shroud 104 includes a lower surface 104a facing the hub side Dwhs.

The description will return to a lifting tool 1.

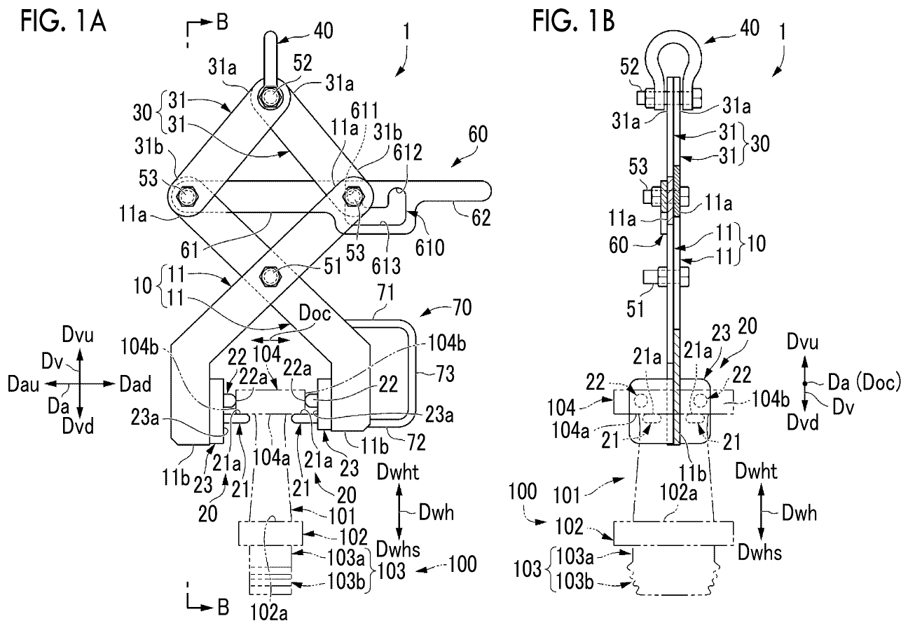

As shown in FIGS. 1A and 1B, the lifting tool 1 in the present embodiment includes a clamp part 10, a lifting part 20, a V-shaped link mechanism 30, an external force application part 40, a locking mechanism 60, a handle part 70, a first connecting pin 51, a second connecting pin 52, and a third connecting pin 53.

### (Clamp Part)

The clamp part 10 forms a main body part in the lifting tool 1 and is a part that generates a force for clamping (restraining) the rotor blade 100.

The clamp part 10 includes a pair of clamp pieces 11.

### (Clamp Piece)

The pair of clamp pieces 11 extend in an up-down direction Dv (an up-down direction in FIGS. 1A and 1B). The up-down direction Dv in the present embodiment coincides with a vertical direction. Hereinafter, an upward side in the up-down direction Dv will be simply referred to as an “upward side Dvu”, and a downward side in the up-down direction Dv will be simply referred to as a “downward side Dvd”. The pair of clamp pieces 11 in the present embodiment are formed of a material such as metal, for example.

The pair of clamp pieces 11 overlap each other and are connected to each other in a rotationally movable manner by the first connecting pin 51. The pair of clamp pieces 11 rotationally move relative to each other about the first connecting pin 51 as a pivot point, thereby forming a cross-link mechanism in which lower ends 11b and upper ends 11a each open and close.

Therefore, the pair of clamp pieces 11 can rotationally move in opposite directions. In the present embodiment, in a case where the pair of clamp pieces 11 each rotationally move in the opposite directions, the rotational movement in a direction in which the upper ends 11a and the lower ends 11b move closer to each other will be referred to as “closing”, and the rotational movement in a direction in which the upper ends 11a and the lower ends 11b move away from each other will be referred to as “opening”.

In addition, a direction in which the upper ends 11a and the lower ends 11b of the pair of clamp pieces 11 move closer to and move away from each other will be referred to as an “opening and closing direction Doc”. Further, in the opening and closing direction Doc, a direction in which the upper ends 11a and the lower ends 11b of the pair of clamp pieces 11 move closer to each other (a direction in which the pair of clamp pieces 11 close) will be referred to as a “closing direction”, and a direction in which the upper ends 11a and the lower ends 11b move away from each other (a direction in which the pair of clamp pieces 11 open) will be referred to as an “opening direction”.

In the present embodiment, the closing direction is set as a direction in which the side surface 104b facing the axial upstream side Dau and the side surface 104b facing the axial downstream side Dad among the side surfaces 104b of the shroud 104 of the rotor blade 100 are pinched when the rotor blade 100 is attached to the rotor shaft 200. It is more preferable for the closing direction to coincide with the axial direction Da when the rotor blade 100 is attached to the rotor shaft 200.

### (Lifting Part)

The lifting part 20 is a part that supports the rotor blade 100 and that pinches and restrains the rotor blade 100 in a state of being interlocked with the clamp part 10. The lifting parts 20 are provided at the lower ends 11b of the pair of clamp pieces 11, respectively.

The lifting part 20 includes a substrate 23, a first member 21, and a second member 22.

### (Substrate)

The substrate 23 is a flat plate-shaped member. The substrate 23 is fixed to the lower end 11b in the clamp part 10 by a fastening member (not shown) such as a bolt. The substrate 23 is formed of a material such as metal, for example. The substrates 23 respectively fixed to the lower ends 11b of the pair of clamp pieces 11 include facing surfaces 23a facing each other.

A pair of facing surfaces 23a facing each other sandwich the side surface 104b facing the axial upstream side Dau and the side surface 104b facing the axial downstream side Dad among the side surfaces 104b of the shroud 104 therebetween when the lifting tool 1 lifts the rotor blade 100.

Therefore, a pair of substrates 23 move closer to each other when the pair of clamp pieces 11 are closed in the closing direction. Additionally, the pair of substrates 23 move away from each other when the pair of clamp pieces 11 are opened in the opening direction. That is, the facing surfaces 23a of the pair of substrates 23 move away from and move closer to each other with the opening and closing of the pair of clamp pieces 11.

### (First Member)

The first member 21 is provided on the facing surface 23a of the substrate 23. The first member 21 is a member that protrudes from the facing surface 23a of each substrate 23 in the closing direction of the lower end 11b. That is, the first members 21 are provided on the substrates 23 to protrude from the facing surfaces 23a in a direction in which the first members 21 move closer to each other.

A plurality of first members 21 in the present embodiment are disposed on the facing surface 23a. The first member 21 is formed of a synthetic resin material. As a material for forming the first member 21 in the present embodiment, for example, MC nylon (registered trademark) or the like can be employed.

The first member 21 includes a planar support surface 21a facing the upward side Dvu when the pair of clamp pieces 11 are closed in the closing direction. The support surface 21a of the first member 21 can face the lower surface 104a of the shroud 104 in the up-down direction Dv and support the lower surface 104a from the downward side Dvd when the pair of facing surfaces 23a sandwich the shroud 104 therebetween.

### (Second Member)

The second member 22 is provided on the facing surface 23a of the substrate 23. The second member 22 is disposed on the upward side Dvu with respect to the first member 21. In addition, a plurality of second members 22 in the present embodiment are disposed on the facing surface 23a. The second member 22 is a member that protrudes from the facing surface 23a of each substrate 23 in the closing direction of the lower end 11b.

The second member 22 protrudes in the closing direction by a protrusion length shorter than that of the first member 21. The “protrusion length” described here means a protrusion length from the substrate 23 in the closing direction. The second member 22 is formed of a synthetic resin material. As a material for forming the second member 22 in the present embodiment, for example, MC nylon (registered trademark) or the like can be employed.

The second member 22 includes an abutting surface 22a that can abut against the side surface 104b of the shroud 104 when the pair of clamp pieces 11 are closed in the closing direction. The abutting surface 22a forms a convex curved shape that is convex from the facing surface 23a of the substrate 23 in the closing direction.

Therefore, when the pair of clamp pieces 11 are closed in the closing direction, the support surfaces 21a of the first members 21 support the lower surface 104a of the shroud 104 from the downward side Dvd, and the abutting surfaces 22a of the second members 22 abut against the side surfaces 104b of the shroud 104, thereby causing the lifting parts 20 to restrain the rotor blade 100. That is, the clamp part 10 and the lifting parts 20 are interlocked with each other, so that the rotor blade 100 can be lifted in a state of being clamped.

### (V-Shaped Link Mechanism)

The V-shaped link mechanism 30 is a link mechanism for opening and closing the clamp part 10. The V-shaped link mechanism 30 is interlocked with the clamp part 10.

The V-shaped link mechanism 30 includes a pair of link pieces 31.

### (Link Piece)

The pair of link pieces 31 extend in the up-down direction Dv. The pair of link pieces 31 overlap each other, and upper ends 31a are connected to each other in a rotationally movable manner by the second connecting pin 52. A lower end 31b of each of the pair of link pieces 31 is connected to the upper end 11a of the corresponding clamp piece 11 in a rotationally movable manner by the third connecting pin 53. The link piece 31 in the present embodiment is formed of a material such as metal, for example.

The lower ends 31b of the pair of link pieces 31 move closer to each other when the clamp pieces 11 are closed about the connected portion of the clamp pieces 11 as a pivot point, and move away from each other when the clamp pieces 11 are opened about the connected portion of the clamp pieces 11 as a pivot point.

(External Force Application Part) The external force application part 40 is connected to the second connecting pin 52 that connects the link pieces 31 to each other, and is a coupling fitting to which a crane wire (not shown) or the like is attached and which is lifted to the upward side Dvu by the wire.

The external force application part 40 is lifted to the upward side Dvu, thereby allowing the rotor blade 100 to be raised to the upward side Dvu through the V-shaped link mechanism 30, the clamp part 10, and the lifting parts 20. In other words, the external force application part 40 can lift the rotor blade 100 by receiving an external force applied from the outside of the lifting tool 1 toward the upward side Dvu.

### (Locking Mechanism)

The locking mechanism 60 is a member that can restrict a rotational movement amount of the pair of clamp pieces 11 in the closing direction and the opening direction. The locking mechanism 60 is provided across the upper ends 11a of the pair of clamp pieces 11. The locking mechanism 60 is formed of a material such as metal, for example.

The locking mechanism 60 in the present embodiment includes a locking plate 61 and a lever portion 62.

### (Locking Plate)

The locking plate 61 is provided across a pair of third connecting pins 53. The locking plate 61 is provided on one third connecting pin 53 of the pair of third connecting pins 53 in a rotationally movable manner. Additionally, a guide hole 610 that allows the other third connecting pin 53 to be guided is formed in a portion of the locking plate 61 on a side opposite to a portion provided with the one third connecting pin 53. The other third connecting pin 53 is disposed inside the guide hole 610.

The guide hole 610 in the present embodiment is composed of a first accommodating hole 611 and a second accommodating hole 612 that are spaced apart from each other and that allow the other third connecting pin 53 to be accommodated in a state in which the other third connecting pin 53 is received, and a connecting hole 613 that connects the first accommodating hole 611 and the second accommodating hole 612.

The first accommodating hole 611 and the second accommodating hole 612 are disposed on the upward side Dvu with respect to the connecting hole 613. The connecting hole 613 extends in one direction across the first accommodating hole 611 and the second accommodating hole 612 on the downward side Dvd. The guide hole 610 including the first accommodating hole 611, the second accommodating hole 612, and the connecting hole 613 forms a U-shape when viewed from the front. The one direction in the present embodiment coincides with the opening and closing direction Doc of the pair of clamp pieces 11.

### (Lever Portion)

The lever portion 62 is provided on the locking plate 61 in an integrated state with the locking plate 61 and is a portion that is operated by a hand of an operator who uses the lifting tool 1. The lever portion 62 in the present embodiment extends in the one direction from an end portion of the locking plate 61 on a side of the other third connecting pin 53 among the one third connecting pin 53 and the other third connecting pin 53.

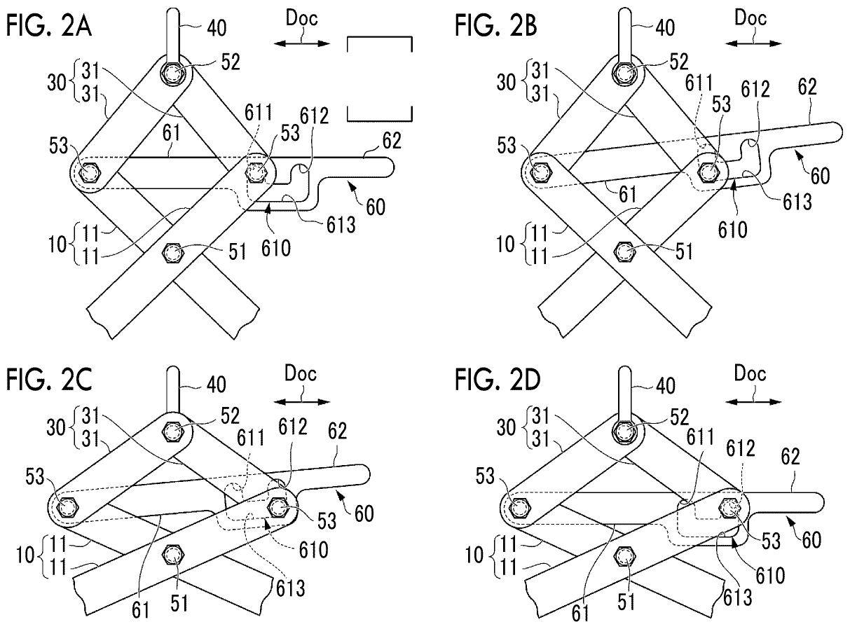

Hereinafter, an operation of the locking mechanism 60 to restrict (lock) the rotational movement amount of the pair of clamp pieces 11 when the lever portion 62 is operated by the hand of the operator will be described with reference to FIGS. 2A to 2D.

In a case where the lever portion 62 is pushed upward to the upward side Dvu when the other third connecting pin 53 is located in the first accommodating hole 611 of the guide hole 610 (FIG. 2A), the other third connecting pin 53 is disposed at an end portion of the connecting hole 613 on a closing direction side (FIG. 2B). Then, the pair of clamp pieces 11 rotationally move in the opening direction, so that the other third connecting pin 53 is guided in the one direction (opening direction) by the connecting hole 613 (FIG. 2C). Then, when the lever portion 62 is pushed downward, the other third connecting pin 53 is disposed in the second accommodating hole 612 (FIG. 2D).

Through the above series of operations, the guide hole 610 allows the pair of clamp pieces 11 to rotationally move (open and close) by the length of the connecting hole 613 and can stop any further rotational movement of the pair of clamp pieces 11 in the opening direction by receiving the other third connecting pin 53 in the second accommodating hole 612.

In addition, in a case where the lever portion 62 is pushed upward to the upward side Dvu when the other third connecting pin 53 is located in the second accommodating hole 612 of the guide hole 610 (FIG. 2D), the other third connecting pin 53 is disposed at an end portion of the connecting hole 613 on an opening direction side (FIG. 2C). Then, the pair of clamp pieces 11 rotationally move in the closing direction, so that the other third connecting pin 53 is guided by the connecting hole 613 in a direction (closing direction) opposite to the above-described one direction (FIG. 2B). Then, in a case where the lever portion 62 is pushed downward, the other third connecting pin 53 is disposed in the first accommodating hole 611 (FIG. 2A).

Through the above series of operations, the guide hole 610 allows the pair of clamp pieces 11 to rotationally move (open and close) by the length of the connecting hole 613 and can stop any further rotational movement of the pair of clamp pieces 11 in the closing direction by receiving the other third connecting pin 53 in the first accommodating hole 611.

Therefore, by shifting the position of the other third connecting pin 53 in the guide hole 610 by using the lever portion 62, the rotational movement amount of the pair of clamp pieces 11 in the opening and closing direction Doc can be restricted.

Hereinafter, for convenience of description, a state of the locking mechanism 60 when the other third connecting pin 53 is disposed in the first accommodating hole 611 will be referred to as a “closed state”, and a state of the locking mechanism 60 when the other third connecting pin 53 is disposed in the second accommodating hole 612 will be referred to as an “open state”.

### (Handle Part)

As shown in FIG. 1A, the handle part 70 is provided on one clamp piece 11 of the pair of clamp pieces 11 and is a part that allows the entire lifting tool 1 to move by being operated by the hand of the operator who uses the lifting tool 1.

Additionally, the handle part 70 allows the rotational movement of the pair of clamp pieces 11 in the opening and closing direction Doc to be adjusted by being pushed upward or pushed downward in the up-down direction Dv by the hand of the operator when the other third connecting pin 53 is disposed in the connecting hole 613 of the guide hole 610. The handle part 70 is disposed on the downward side Dvd with respect to the first connecting pin 51 to which the pair of clamp pieces 11 are connected.

The handle part 70 in the present embodiment includes an upper horizontal bar 71, a lower horizontal bar 72, and a vertical bar 73.

The upper horizontal bar 71 extends in one direction (opening direction) which is a direction in which the lever portion 62 extends from the clamp piece 11. The lower horizontal bar 72 is disposed on the downward side Dvd with respect to the upper horizontal bar 71. The lower horizontal bar 72 extends from the clamp piece 11 in the above-described one direction. The vertical bar 73 is a portion gripped by the hand of the operator and connects the upper horizontal bar 71 and the lower horizontal bar 72 in the up-down direction Dv.

### Blade Attachment Method

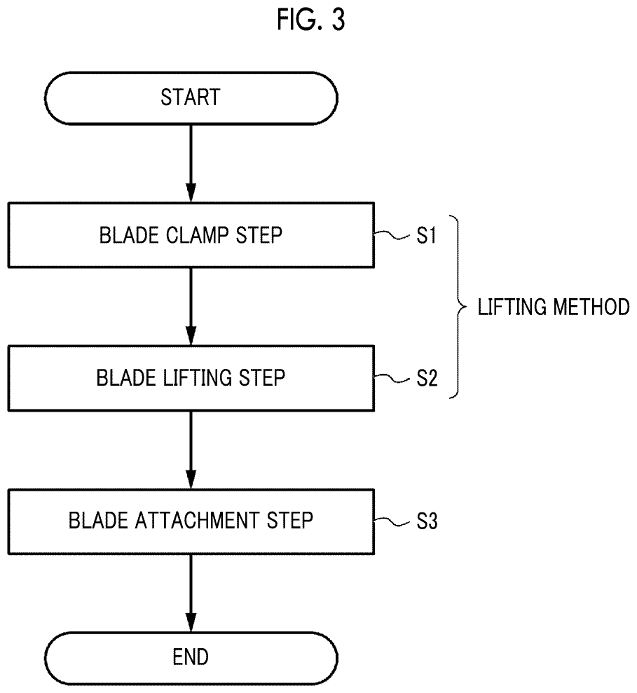

Subsequently, a blade attachment method in the present embodiment will be described with reference to FIG. 3. In the blade attachment method, a blade clamp step S1, a blade lifting step S2, and a blade attachment step S3 are executed. In addition, in the present embodiment, the lifting method of the rotor blade 100 is realized by executing the blade clamp step S1 and the blade lifting step S2.

### (Blade Clamp Step)

The blade clamp step S1 is a step of causing the lifting tool 1 to clamp the rotor blade 100. First, in the blade clamp step S1, the locking mechanism 60 is set to the open state. Then, the closing direction of the pair of clamp pieces 11 in the lifting tool 1 is set to a direction in which the side surface 104b facing the axial upstream side Dau and the side surface 104b facing the axial downstream side Dad among the side surfaces 104b of the shroud 104 are pinched when the rotor blade 100 is attached to the rotor shaft 200. In this case, the operator moves the entire lifting tool 1 by manipulating the handle part 70. The rotor blade 100 itself may be moved toward the lifting tool 1.

That is, the entire lifting tool 1 is moved so that the shroud 104 of the rotor blade 100 is sandwiched between the pair of lifting parts 20. Then, the lever portion 62 is pushed upward to the upward side Dvu, the pair of clamp pieces 11 are rotationally moved in the closing direction, and the lever portion 62 is pushed downward to the downward side Dvd, whereby the locking mechanism 60 is set to the closed state. As a result, the support surface 21a of the first member 21 supports the lower surface 104a of the shroud 104, and the abutting surface 22a of the second member 22 abuts against the side surface 104b of the shroud 104.

### (Blade Lifting Step)

The blade lifting step S2 is a step executed after the blade clamp step S1, in which the rotor blade 100 is lifted to the upward side Dvu. In the blade lifting step S2, the external force toward the upward side Dvu is applied to the external force application part 40 to lift the rotor blade 100 to the upward side Dvu. Specifically, the crane wire or the like is attached to the external force application part 40, and the external force application part 40 is lifted to the upward side Dvu by the wire, so that the rotor blade 100 is lifted to the upward side Dvu together with the lifting tool 1.

### (Blade Attachment Step)

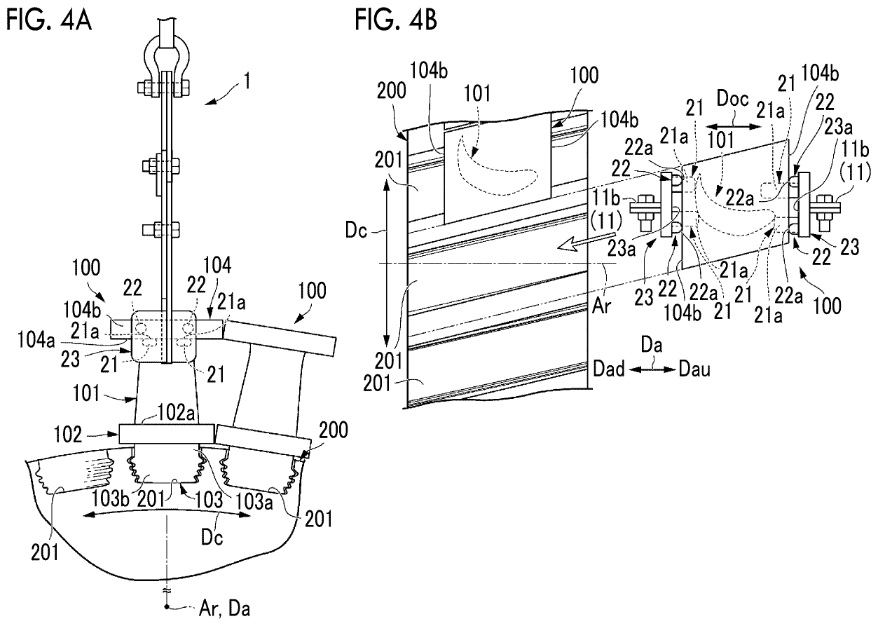

The blade attachment step S3 is a step executed after the blade lifting step S2, in which the rotor blade 100 is attached to the rotor shaft 200 of the turbine. Specifically, as shown in FIGS. 4A and 4B, in a state in which the rotor blade 100 is lifted by the lifting tool 1, the blade root 103b of the shaft attachment portion 103 in the rotor blade 100 is inserted into the blade root groove 201 formed in the rotor shaft 200 from the axial direction Da.

In this case, the blade root 103b can be inserted into the blade root groove 201 in a state in which the rotor blade 100 is lifted by the lifting tool 1, that is, in a state in which the blade root 103b is raised away from an inner surface of the blade root groove 201. In the present embodiment, the blade root 103b is inserted from the axial upstream side Dau along a direction in which the blade root groove 201 extends. After the insertion of the blade root 103b into the blade root groove 201 is completed, the lifting tool 1 is detached from the rotor blade 100.

By executing each of the above-mentioned steps, the rotor blade 100 is lifted by the lifting tool 1, and the rotor blade 100 is attached to the rotor shaft 200.

### (Operations and Effects)

In the above-described configuration, when the rotor blade 100 is lifted by the lifting tool 1, the shroud 104 of the rotor blade 100 is supported from the downward side Dvd by the support surface 21a of the first member 21 of each lifting part 20, and the shroud 104 of the rotor blade 100 is pinched by the abutting surface 22a of the second member 22 of each lifting part 20. Consequently, when the blade root 103b of the rotor blade 100 is inserted into the blade root groove 201, the entire load of the rotor blade 100 is not transferred to the blade root groove 201 as compared with a case where the rotor blade 100 is released from the lifted state. In other words, when the blade root 103b of the rotor blade 100 is inserted into the blade root groove 201 of the rotor shaft 200, it is possible to prevent the load of the rotor blade 100 from being applied to the blade root groove 201. Therefore, the rotor blade 100 can be smoothly attached to the rotor shaft 200.

Additionally, since the protrusion length of the second member 22 is shorter than the protrusion length of the first member 21, for example, rotationally moving the clamp part 10 to open in a direction opposite to the closing direction can achieve a state in which the shroud 104 of the rotor blade 100 is supported only by the first member 21. As a result, it is possible to more finely adjust the position, the orientation, and the like of the rotor blade 100 while maintaining the state in which the rotor blade 100 is supported by the first member 21.

In addition, in the above-described configuration, each upper end 11a of the pair of clamp pieces 11 of the clamp part 10 is connected to the lower end 31b of each of the pair of link pieces 31 of the V-shaped link mechanism 30, and the external force application part 40 is connected to the upper ends 31a of the pair of link pieces 31, which are connected to each other. Consequently, since the weight of the lifting tool 1 and the load of the rotor blade 100 act on the downward side Dvd when the rotor blade 100 is lifted by the external force applied to the external force application part 40, the force for rotationally moving the pair of link pieces 31 in the closing direction continues to be applied to the V-shaped link mechanism 30. In other words, a force for tightening the pair of link pieces 31 in the closing direction continues to be applied. That is, when the rotor blade 100 is lifted, the upper ends 31a of the pair of link pieces 31 connected to the external force application part 40 become tighter. Therefore, the rotor blade 100 can be more firmly pinched by the second members 22 of the pair of lifting parts 20.

Further, with the above-described configuration, the opening and closing direction Doc of the lower ends 11b of the pair of clamp pieces 11 of the clamp parts 10 and the axial direction Da are aligned with each other. Therefore, for example, when the rotor blade 100 is attached to the rotor shaft 200, it is possible to prevent the lifting tool 1 from interfering with the adjacent rotor blade 100 that is already attached to the rotor shaft 200. Accordingly, the rotor blade 100 can be more smoothly attached to the rotor shaft 200.

Additionally, with the above-described configuration, since the rotational movement amount of the pair of clamp pieces 11 is restricted by the locking mechanism 60, the movement of the lifting parts 20 in the up-down direction Dv due to the rotational movement of the pair of clamp pieces 11 can be restricted. Therefore, it is possible to further prevent the load from being applied from the rotor blade 100 to the blade root groove 201 when the rotor blade 100 is attached to the rotor shaft 200. Further, since restricting the rotational movement amount of the pair of clamp pieces 11 restricts the movement of the lifting parts 20 in the closing direction, it is possible to prevent the pinching force of a pair of second members 22 from being excessively applied to the shroud 104.

In addition, in the above-described configuration, since pushing the handle part 70 upward or downward in the up-down direction Dv allows the rotational movement of the pair of clamp pieces 11 to be adjusted, the position of the rotor blade 100 in the up-down direction Dv can be adjusted with high accuracy.

Further, in the above-described configuration, the first member 21 and the second member 22 of the lifting part 20 are formed of a synthetic resin material. Therefore, it is possible to prevent damage to the shroud 104 from the support surface 21a of the first member 21 and the abutting surface 22a of the second member 22 when the lifting tool 1 lifts the rotor blade 100, for example, as compared with a case where the first member 21 and the second member 22 are formed of a metal material.

Furthermore, in the above-described configuration, the facing surface 23a of the substrate 23 of the lifting part 20 provided on each of the lower ends 11b of the pair of clamp pieces 11 expands parallel to a direction in which the side surface 104b facing the axial upstream side Dau and the side surface 104b facing the axial downstream side Dad among the side surfaces 104b of the shroud 104 expand. Consequently, the plurality of first members 21 and the plurality of second members 22 in the lifting part 20 can be disposed on the facing surface 23a with a high degree of freedom. Therefore, in accordance with the shape of the shroud 104, the shroud 104 can be supported in a well-balanced manner by the support surface 21a of the first member 21, and the abutting surface 22a of the second member 22 can abut against an appropriate location of the side surface 104b of the shroud 104.

### Other Embodiments

The embodiment of the present disclosure has been described in detail hereinabove with reference to the drawings; however, a specific configuration is not limited to the configuration of the embodiment, and additions, omissions, and substitutions, and other changes to the configuration are possible without departing from the gist of the present disclosure.

The lifting tool 1 described in the above-described embodiment need not include the locking mechanism 60.

Additionally, the handle part 70 described in the above-described embodiment may be provided on both of the pair of clamp pieces 11.

In addition, the abutting surface 22a of the second member 22 described in the above-described embodiment may be, for example, spherical.

Further, in the above-described embodiment, a case where the first member 21 and the second member 22 are formed of a synthetic resin material has been described, but the present disclosure is not limited thereto. Instead of the configuration in which the entire first member 21 and second member 22 are formed of a synthetic resin material, for example, only a portion (surface layer portion) that constitutes the support surface 21a of the first member 21 and the abutting surface 22a of the second member 22, that is, a part of the first member 21 and a part of the second member 22, may be formed of a synthetic resin material.

Furthermore, the gas turbine blade 100 and the lifting tool 1 described in the above-described embodiment can be used as a set. That is, the gas turbine blade 100 and the lifting tool 1 may be implemented as a set.

### Appendix

The lifting tool and the lifting method described in the embodiment are understood as follows, for example.
(1) The lifting tool 1 according to a first aspect is the lifting tool 1 for the gas turbine blade 100 provided with the shroud 104 at the tip, the lifting tool 1 including: the clamp part 10 that includes the pair of clamp pieces 11 extending in the up-down direction Dv and connected to each other in a rotationally movable manner and that forms the cross-link mechanism in which the lower ends 11b and the upper ends 11a of the pair of clamp pieces 11 each open and close; and the pair of lifting parts 20 that are provided at the lower ends 11b of the pair of clamp pieces 11, respectively, in which the lifting parts 20 each include the first member 21 that protrudes from the lower end 11b of the clamp piece 11 in the closing direction of the lower end 11b and that includes the support surface 21a configured to support the lower surface 104a of the shroud 104 from below, and the second member 22 that protrudes in the closing direction above the first member 21 by a protrusion length shorter than that of the first member 21 and that includes the abutting surface 22a configured to abut against the side surface 104b of the shroud 104.

Consequently, when the rotor blade 100 is lifted by the lifting tool 1, the lower surface 104a of the shroud 104 of the rotor blade 100 is supported from below by the support surface 21a of the first member 21 of each lifting part 20, and the side surface 104b of the shroud 104 of the rotor blade 100 is pinched by the abutting surface 22a of the second member 22 of each lifting part 20. That is, the rotor blade 100 is restrained by the second member 22 while being supported by the first member 21. Therefore, since the rotor blade 100 is more stably suspended, the entire load of the gas turbine blade 100 is not transferred to the groove, for example, when the gas turbine blade 100 is inserted into the groove of the rotor shaft 200.
(2) The lifting tool 1 according to a second aspect is the lifting tool 1 according to (1), in which the V-shaped link mechanism 30 that includes the pair of link pieces 31 whose upper ends 31a are connected to each other in a rotationally movable manner, with each lower end 31b being connected to the upper end 11a of the corresponding clamp piece 11 in a rotationally movable manner, and the external force application part 40 that is provided at the upper end 31a of the V-shaped link mechanism 30 may be further provided.

Consequently, since the weight of the lifting tool 1 and the load of the rotor blade 100 act on the downward side Dvd when the gas turbine blade 100 is lifted by the external force applied to the external force application part 40, the force for rotationally moving the pair of link pieces 31 in the closing direction continues to be applied to the V-shaped link mechanism 30.

(3) The lifting tool 1 according to a third aspect is the lifting tool 1 according to (1) or (2), in which the closing direction may be a direction in which the side surface 104b facing the upstream side and the side surface 104b facing the downstream side among the side surfaces 104b of the shroud 104 are pinched.

Consequently, for example, when the gas turbine blade 100 is attached to the rotor shaft 200, it is possible to prevent the lifting tool 1 from interfering with the shroud 104 of the adjacent gas turbine blade 100 that is already attached to the rotor shaft 200.
(4) The lifting tool 1 according to a fourth aspect is the lifting tool 1 according to (2), in which the locking mechanism 60 that is provided across the upper ends 11a of the pair of clamp pieces 11 and that is configured to restrict the rotational movement amount of the pair of clamp pieces 11 in the closing direction and the opening direction opposite to the closing direction may be further provided.

Consequently, the movement of the lifting parts 20 in the up-down direction Dv due to the rotational movement of the pair of clamp pieces 11 can be restricted.
(5) The lifting tool 1 according to a fifth aspect is the lifting tool 1 according to (4), in which the pair of connecting pins that connect the upper ends 11a of the pair of clamp pieces 11 and the lower ends 31b of the pair of link pieces 31 to each other may be further provided, the locking mechanism 60 may include the locking plate 61 that is provided on one connecting pin of the pair of connecting pins in a rotationally movable manner and that is formed with the guide hole 610 which allows the other connecting pin to be guided, and the lever portion 62 that extends from a side of the other connecting pin in the locking plate 61, and the guide hole 610 may include the first accommodating hole 611 and the second accommodating hole 612 that are spaced apart from each other and that allow the other connecting pin to be accommodated in a state in which the other connecting pin is received, and the connecting hole 613 that allows the other connecting pin to be guided from the first accommodating hole 611 to the second accommodating hole 612, or from the second accommodating hole 612 to the first accommodating hole 611, when the lever portion 62 is pushed upward to the upward side Dvu in a state in which the other connecting pin is located in the first accommodating hole 611 or the second accommodating hole 612, and the pair of clamp pieces 11 are rotationally moved in the closing direction or the opening direction.

Consequently, the locking mechanism 60 can be realized with a more specific configuration.
(6) The lifting tool 1 according to a sixth aspect is the lifting tool 1 according to any one of (1) to (5), in which the handle part 70 that is provided on the downward side Dvd with respect to a portion where the pair of clamp pieces 11 are connected to each other and that allows the rotational movement of the pair of clamp pieces 11 to be adjusted by being pushed upward or pushed downward in the up-down direction Dv may be further provided.

Consequently, the rotational movement of the pair of clamp pieces 11 can be adjusted. Therefore, the position of the gas turbine blade 100 in the up-down direction Dv can be adjusted with high accuracy.
(7) The lifting tool 1 according to a seventh aspect is the lifting tool 1 according to any one of (1) to (6), in which the first member 21 and the second member 22 may be formed of a synthetic resin material.

Consequently, it is possible to prevent damage to the shroud 104 from the first member 21 and the second member 22 when the lifting tool 1 lifts the rotor blade 100, for example, as compared with a case where the first member 21 and the second member 22 are formed of a metal material.
(8) The lifting method according to an eighth aspect is the lifting method of lifting the gas turbine blade 100 provided with the shroud 104 at the tip by using the lifting tool 1, the lifting tool 1 including the clamp part 10 that includes the pair of clamp pieces 11 extending in the up-down direction Dv and connected to each other in a rotationally movable manner and that forms the cross-link mechanism in which the lower ends 11b and the upper ends 11a of the pair of clamp pieces 11 each open and close, and the pair of lifting parts 20 that are provided at the lower ends 11b of the pair of clamp pieces 11, respectively, the lifting parts 20 each including the first member 21 that protrudes from the lower end 11b of the clamp piece 11 in the closing direction of the lower end 11b and that includes the support surface 21a configured to support the lower surface 104a of the shroud 104 from below, and the second member 22 that protrudes in the closing direction above the first member 21 by a protrusion length shorter than that of the first member 21 and that includes the abutting surface 22a configured to abut against the side surface 104b of the shroud 104, the lifting method including: a blade clamp step S1 of supporting the lower surface 104a of the shroud 104 with the first member 21 and abutting the second member 22 against the side surface 104b of the shroud 104, with the closing direction set as a direction in which the side surface 104b facing the upstream side and the side surface 104b facing the downstream side among the side surfaces 104b of the shroud 104 are pinched; and the blade lifting step S2 of lifting the lifting tool 1 to the upward side Dvu.

### REFERENCE SIGNS LIST

1: lifting tool
10: clamp part
11: clamp piece
11a, 31a: upper end
11b, 31b: lower end
20: lifting part
21: first member
21a: support surface
22: second member
22a: abutting surface
23: substrate
23a: facing surface
30: V-shaped link mechanism
31: link piece
40: external force application part
51: first connecting pin
52: second connecting pin
53: third connecting pin
60: locking mechanism
61: locking plate
62: lever portion
70: handle part
71: upper horizontal bar
72: lower horizontal bar
73: vertical bar
100: gas turbine blade
101: rotor blade body
101a: leading edge
101b: trailing edge
101c: ventral surface
101d: dorsal surface
102: platform
102a: gas path surface
103: shaft attachment portion
103a: shank
103b: blade root
104: shroud
104a: lower surface
104b: side surface
200: rotor shaft
201: blade root groove
610: guide hole
611: first accommodating hole
612: second accommodating hole
613: connecting hole
Ar: axis
Da: axial direction
Dad: axial downstream side
Dau: axial upstream side
Dc: circumferential direction
Doc: opening and closing direction
Dwh: blade height direction
Dwhs: hub side
Dwht: tip side
Dv: up-down direction
Dvd: downward side
Dvu: upward side
S1: blade clamp step
S2: blade lifting step
S3: blade attachment step

1. A lifting tool for a gas turbine blade provided with a shroud at a tip, the lifting tool comprising:
a clamp part that includes a pair of clamp pieces extending in an up-down direction and connected to each other in a rotationally movable manner and that forms a cross-link mechanism in which lower ends and upper ends of the pair of clamp pieces each open and close; and
a pair of lifting parts that are provided at the lower ends of the pair of clamp pieces, respectively,
wherein the lifting parts each include
a first member that protrudes from the lower end of the clamp piece in a closing direction of the lower end and that includes a support surface configured to support a lower surface of the shroud from below, and
a second member that protrudes in the closing direction above the first member by a protrusion length shorter than that of the first member and that includes an abutting surface configured to abut against a side surface of the shroud.

2. The lifting tool according to claim 1, further comprising:
a V-shaped link mechanism that includes a pair of link pieces whose upper ends are connected to each other in a rotationally movable manner, with each lower end being connected to the upper end of the corresponding clamp piece in a rotationally movable manner; and
an external force application part that is provided at an upper end of the V-shaped link mechanism.

3. The lifting tool according to claim 1,
wherein the closing direction is a direction in which a side surface facing an upstream side and a side surface facing a downstream side among the side surfaces of the shroud are pinched.

4. The lifting tool according to claim 2, further comprising:
a locking mechanism that is provided across the upper ends of the pair of clamp pieces and that is configured to restrict a rotational movement amount of the pair of clamp pieces in the closing direction and an opening direction opposite to the closing direction.

5. The lifting tool according to claim 4, further comprising:
a pair of connecting pins that connect the upper ends of the pair of clamp pieces and the lower ends of the pair of link pieces to each other,
wherein the locking mechanism includes
a locking plate that is provided on one connecting pin of the pair of connecting pins in a rotationally movable manner and that is formed with a guide hole which allows the other connecting pin to be guided, and
a lever portion that extends from a side of the other connecting pin in the locking plate, and
the guide hole includes
a first accommodating hole and a second accommodating hole that are spaced apart from each other and that allow the other connecting pin to be accommodated in a state in which the other connecting pin is received, and
a connecting hole that allows the other connecting pin to be guided from the first accommodating hole to the second accommodating hole, or from the second accommodating hole to the first accommodating hole, when the lever portion is pushed upward to an upward side in a state in which the other connecting pin is located in the first accommodating hole or the second accommodating hole, and the pair of clamp pieces are rotationally moved in the closing direction or the opening direction.

6. The lifting tool according to claim 1, further comprising:
a handle part that is provided on a downward side with respect to a portion where the pair of clamp pieces are connected to each other and that allows rotational movement of the pair of clamp pieces to be adjusted by being pushed upward or pushed downward in the up-down direction.

7. The lifting tool according to claim 1,
wherein the first member and the second member are formed of a synthetic resin material.

8. A lifting method of lifting a gas turbine blade provided with a shroud at a tip by using a lifting tool, the lifting tool including a clamp part that includes a pair of clamp pieces extending in an up-down direction and connected to each other in a rotationally movable manner and that forms a cross-link mechanism in which lower ends and upper ends of the pair of clamp pieces each open and close, and a pair of lifting parts that are provided at the lower ends of the pair of clamp pieces, respectively, the lifting parts each including a first member that protrudes from the lower end of the clamp piece in a closing direction of the lower end and that includes a support surface configured to support a lower surface of the shroud from below, and a second member that protrudes in the closing direction above the first member by a protrusion length shorter than that of the first member and that includes an abutting surface configured to abut against a side surface of the shroud, the lifting method comprising:
a blade clamp step of supporting the lower surface of the shroud with the first member and abutting the second member against the side surface of the shroud, with the closing direction set as a direction in which a side surface facing an upstream side and a side surface facing a downstream side among the side surfaces of the shroud are pinched; and
a blade lifting step of lifting the lifting tool to an upward side.

9. The lifting tool according to claim 2,
wherein the closing direction is a direction in which a side surface facing an upstream side and a side surface facing a downstream side among the side surfaces of the shroud are pinched.

10. The lifting tool according to claim 2, further comprising:
a handle part that is provided on a downward side with respect to a portion where the pair of clamp pieces are connected to each other and that allows rotational movement of the pair of clamp pieces to be adjusted by being pushed upward or pushed downward in the up-down direction.

11. The lifting tool according to claim 2,
wherein the first member and the second member are formed of a synthetic resin material.
